(19) United States
(12) Patent Application Publication
(10) Pub. No.: US 2004/0159993 A1
(43) Pub. Date: Aug. 19, 2004

(54) Spring strut unit with height-adjustable spring plate

(75) Inventors: Alexander Miller, Wurzburg (DE); Manfred Schuler, Dittelbrunn (DE); Klaus Stretz, Hassfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/718,820

(22) Filed: Nov. 21, 2003

(30) Foreign Application Priority Data
Dec. 2, 2002 (DE) 102 56 407.8

(51) Int. Cl. F16F 1/06

(52) U.S. Cl. 267/179

(57) ABSTRACT

Spring strut unit, comprising a cylinder, with respect to which a spring plate can be shifted axially for the purpose of adjusting the position of the cylinder. The spring plate has a sleeve section, which establishes the connection to the cylinder, where, on the cylinder side of the unit, a chamber is provided, which is at least partially filled with initially formable material, where the sleeve section is in contact with the initially formable material, which, when in the solidified state, transmits supporting forces from the cylinder to the spring plate. In the path of force transmission from the spring plate to the cylinder, a rotation-proof connection is provided, which determines the position of the spring plate with respect to the cylinder.

### BACKGROUND OF THE INVENTION

1. Field of the Invention

The invention pertains to a spring strut unit, also known as a MacPherson strut, including a cylinder and a height-adjustable spring plate, where the spring plate has a sleeve section which is used to produce the connection to the cylinder.

2. Description of the Related Art

A spring strut unit with a detachable spring plate is known from DE 85 10 058 U1; here the spring plate is supported in a retaining ring. The retaining ring itself can be attached independently of the spring plate to the cylinder of the spring strut unit; the assembly thus formed can then be coated as a single structural component. The height at which the spring plate is set is determined by the retaining ring and cannot be changed.

DE 198 51 019 C1 discloses a spring strut unit with a cylinder that carries a retaining ring for a spring plate, which can be adjusted and held permanently in the desired position. The retaining ring has at least one groove, into which at least one circumferential area of a sleeve section of the spring plate can be radially deformed. The extent to which the sleeve section is overlapped by the groove determines the maximum distance by which the height of the spring plate can be adjusted.

In addition, a spring assembly for motor vehicles is known from DE 197 44 757 A1, in which the height of a spring plate can be actively changed by the use of a hydraulic medium. A spring assembly of this type is intended in particular for vehicles of the luxury class, in which it its expected that the spring plate will have to be adjusted rather frequently in conjunction with the process of keeping the vehicle body level.

### SUMMARY OF THE INVENTION

The object of the present invention is to provide a spring strut unit with a height-adjustable spring plate, the position of which is also oriented in the circumferential direction.

According to the invention, this task is accomplished in that, on the cylinder side of the unit, a chamber is provided, which is at least partially filled with an initially formable material, where the sleeve section is in contact with the initially formable material, which, when in the solidified state, transmits supporting forces from the cylinder to the spring plate, where, in the path of force transmission from the spring plate to the cylinder, a positive rotation-proof connection is provided, which determines the position of the spring plate in the circumferential direction with respect to the cylinder.

Plastic, but also metallic materials, can be used as the initially formable material. Once the height has been properly adjusted, the spring plate is held in its predetermined position, and the chamber is filled with an appropriate amount of the initially formable material.

The chamber on the cylinder side of the unit is formed by a support ring, which is permanently connected axially to the cylinder.

In an advantageous elaboration, the support ring has a sleeve and a bottom, and at least part of the sleeve section of the spring plate is held inside the sleeve of the support ring. In this variant, the support ring forms the chamber for the initially formable material.

To ensure easy access in a device of the type in question, the support ring has a connecting opening for the initially formable material.

In a variant of the invention, the sleeve section of the spring plate has at least one anti-rotation profile, which is limited in the circumferential direction, and which is able to receive the initially formable material. The positional orientation in the circumferential direction is ensured not only by the shear strength of the hardened, initially formable material in the chamber of the support ring but also by the connection between the initially formable material and the anti-rotation profile of the spring plate.

Alternatively or in addition, the support ring can have at least one engagement profile, which is limited in the circumferential direction, and which is also able to receive the initially formable material.

In a further embodiment, the engagement profile and/or the anti-rotation profile is formed by at least one pocket, which is limited in the circumferential direction. A pocket has lateral boundary surfaces, against which the initially formable material can support itself in the circumferential direction.

The gap between the sleeve section and the support ring should not be too wide, or otherwise the initially formable material will bulge out over the edge. For this reason, the pocket extends no farther than a point below the edge of the support ring.

Especially when the support ring has an engagement profile, it is effective for the anti-rotation profile of the sleeve section of the spring plate to be on the inside wall, which ensures that the wall thickness of the initially formable material in the chamber of the support ring will be thin. There will be no spatial overlap between the anti-rotation profile and the engagement profile.

Another way in which the engagement profile can be effectively realized consists in providing it in the bottom of the support ring. It is almost impossible for bubbles or defects to form on the bottom, because the pressure of the spring plate inside the chamber always ensures that the initially formable material is packed down inside the chamber.

Alternatively or in addition, the anti-rotation profile in the sleeve section of the spring plate can be formed by at least one opening. The advantage of this measure is that the initially formable material becomes distributed more quickly along the inside and outside walls of the sleeve section inside the chamber than it does in the case of a pocket-shaped profile.

In the case of the embodiments described above, the initially formable material takes over the function of the anti-rotation device. Alternatively, it is possible to install an anti-rotation sleeve between the spring plate and the support ring; this sleeve then engages in the engagement profile of the support ring and in the anti-rotation profile of the spring plate.

The anti-rotation sleeve has a flow connection between the end surface of the sleeve section and the connecting opening in the support ring. The goal here is to provide an effective supply of initially formable material to the functional surface of the spring plate responsible for the height adjustment function.

It is also provided that the anti-rotation sleeve inside the engagement profile of the support ring is supported permanently in the axial direction. This prevents the anti-rotation sleeve from floating upward when the initially formable material is injected and prevents the chamber from being filled in an undefined manner.

Another variant is characterized in that the engagement profile of the support ring engages in the anti-rotation profile of the spring plate. A direct, positive connection is present between the support ring and the spring plate.

The support ring has, as its engagement profile, at least one radial projection, which engages in the anti-rotation profile of the spring plate.

To avoid leakage at the support ring, the radial projection on the support ring is located outside the chamber.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1 and 2 show a rotation-proof connection obtained by filling the profile of the support ring for the spring plate with initially formable material;

FIG. 3 shows an anti-rotation sleeve between the spring plate and the support ring; and

FIG. 4 shows a direct rotation-proof connection between the spring plate and the support ring.

### DETAILED DESCRIPTION OF THE PRESENTLY PREFERRED EMBODIMENTS

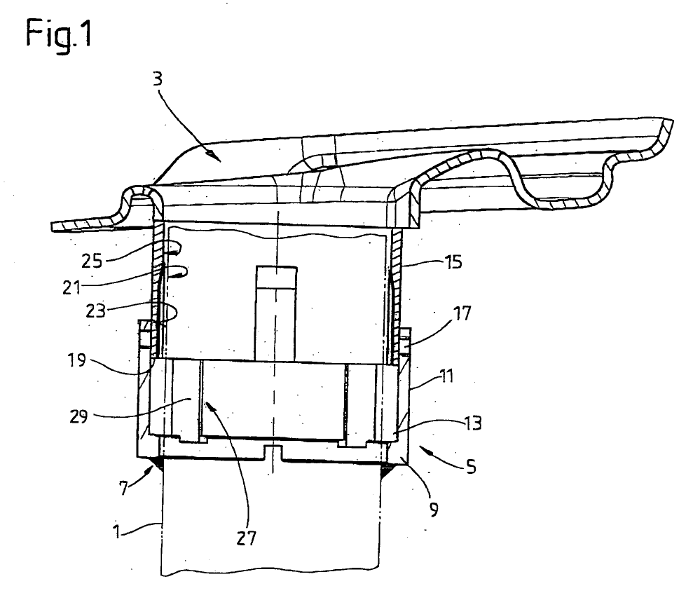

FIG. 1 is limited to a section of a cylinder 1, which carries a spring plate 3. The cylinder can be part of a spring strut unit or of a pneumatic spring. Inside the cylinder, a piston can be installed so that it can move in the axial direction, or a coaxial pressure tube containing a working medium can be provided.

On the cylinder side of the unit, a support ring 5 is attached in a defined circumferential position; various fastening means such as a weld 7 are conceivable. The support ring 5 consists of a bottom 9 and a sleeve 11, so that the support ring and the cylinder together form a ring-shaped chamber 13. The lower end of a sleeve section 15 of the spring plate 3 is inserted into the chamber, where it is guided with freedom of axial movement. Through a connecting opening 17 in the support ring 5, the chamber 13 can be filled with an initially formable material at least up as far as the lower end surface 19 of the sleeve section 15. Suitable initially formable materials include liquid plastics or possibly hardenable metallic materials.

When the cylinder 1 is a component of a vibration damper, a retaining device (not shown) is placed, at the end of the vehicle assembly process, on the spring plate 3 in order to level the vehicle horizontally. As this is being done, the sleeve section 15 of the spring plate 3 slides to a certain point inside the chamber 13. Once the height has been adjusted properly, the chamber is filled with the initially formable material at least up as far as the lower end surface of the sleeve section. As soon as the initially formable material has hardened sufficiently, the retaining device can be removed, and thus the vehicle is now horizontally level regardless of the equipment with which it may be loaded in the individual case.

A spring plate on the spring strut unit is also frequently oriented in the circumferential direction in order, for example, to fit a specific installation space or in order to obtain a specific working characteristic of the spring. For this purpose, a rotation-proof connection is provided in the path along which forces are transmitted from the spring plate 3 via the support ring 5 to the cylinder; this device determines the position of the spring plate in the circumferential direction with respect to the cylinder. For this purpose, the sleeve section 15 of the spring plate has at least one anti-rotation profile 21, limited in the circumferential direction, to accept the initially formable material. In the present exemplary embodiment, the anti-rotation profile is formed by at least one pocket 23 of limited circumferential extent in the inside wall 25 of the sleeve section 15 of the spring plate 3. The support ring also has an engagement profile 27 of limited circumferential extent in the form of a pocket 29 to accept the initially formable material. The two pockets 23; 29 are designed with respect to their length and position on their respective components in such a way that, even at maximum projection of the sleeve section 15 from the support ring, the pockets extend no farther than a point below the edge of the support ring, so that the narrowest possible gap is present with respect to the sleeve section at the upper edge of the support ring. When the chamber 13 is being filled with the initially formable material, the pockets of the engagement profile and of the anti-rotation profile are also at least partially filled, so that the hardened material, which can support itself against the side-walls of the pockets, establishes the positive rotation-proof connection between the spring plate 3 and the cylinder 1.

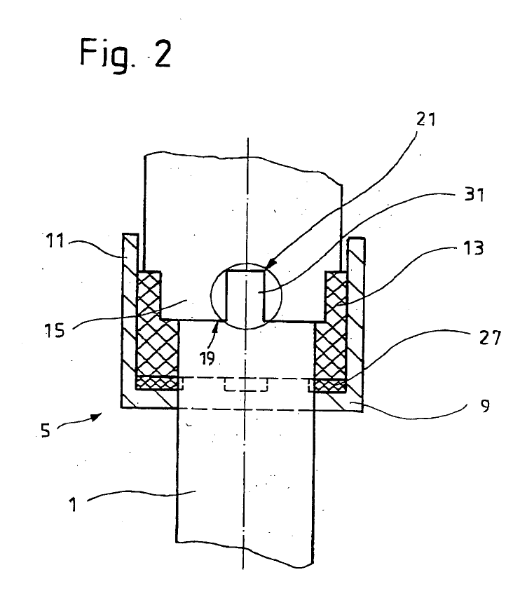

The same principle as that described in FIG. 1 is also used in the variant according to FIG. 2. The difference, however, is that the engagement profile 27 in the support ring 5 consists of pockets 29 in the bottom 9 and that the anti-rotation profile 21 consists of openings 31, which in this case proceed from the end surface 19 of the sleeve section 15 toward the spring plate 3.

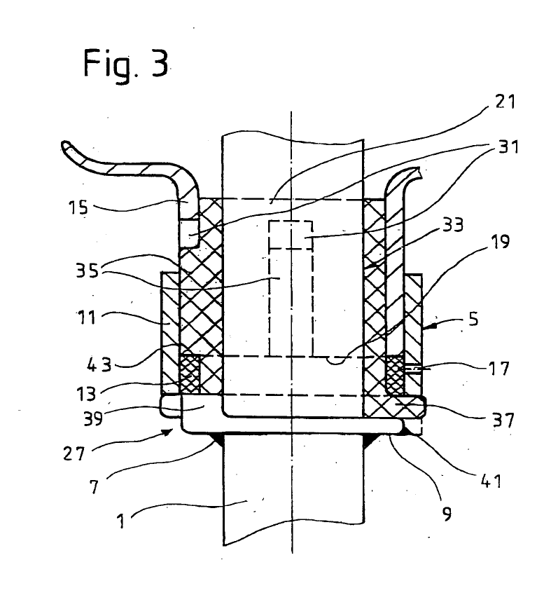

In FIG. 3, an anti-rotation sleeve 33 is used between the spring plate 3, i.e., the sleeve section 15 of the spring plate, and the support ring 5; this anti-rotation sleeve has a profile, in this case a web 35, which engages in the opening 31 of the anti-rotation profile 21, and at least one projection 37, which engages in the engagement profile of the support ring. The projection 37 can also be designed as a circular circumferential ring, which has at least one recess to accept a segment 39 of the engagement profile 27 on the bottom 9. The sleeve 11 of the support ring 5 does not necessarily have to be connected permanently to the bottom, because the load exerted by the spring plate is directed down toward the bottom 9 of the support ring. It is also possible, however, to provide a permanent connection such as a weld 41 between the bottom 9 and the sleeve, in which case the sleeve 11 would extend beyond the projection 37 as far as the bottom 9, as the broken line illustrates. Alternatively, a clamping type of connection could be provided between the bottom and sleeve. In either case, the anti-rotation sleeve 33 is supported in a permanent axial position inside the engagement profile 27 of the support ring 5.

A circumferential shoulder 43, facing in the direction of the bottom 9, is provided on the anti-rotation sleeve 33. This shoulder represents a flow connection between the end surface 19 of the sleeve section 15 and the connecting opening 17. Ultimately, this flow connection also forms the chamber 13 at the same time.

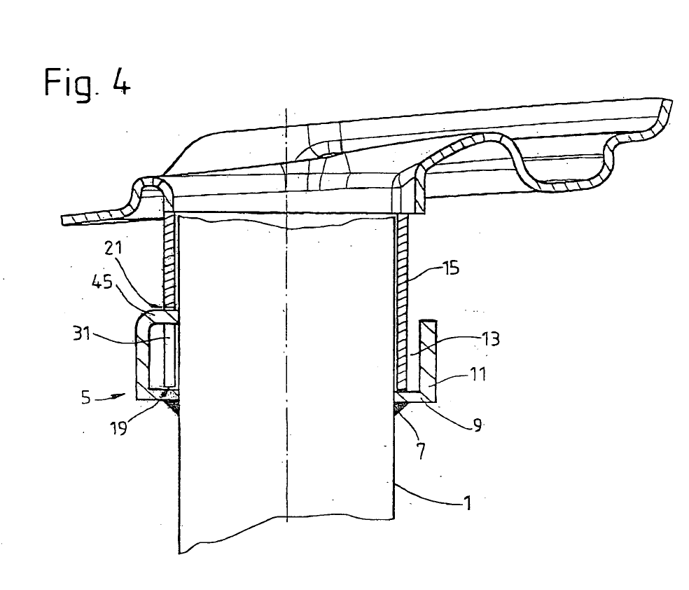

In FIG. 4, the rotation-proof connection exists directly between the spring plate 3 or, more precisely, its sleeve section 15, and the sleeve 11 of the support ring 5. For this purpose, the support ring has at least one radial projection 45 serving as the engagement profile, which engages in the anti-rotation profile 21 of the spring plate 3. The anti-rotation profile 21 is itself formed by an opening 31, which extends from the end surface 19 of the sleeve section 15 toward the spring plate 3. As can be seen in FIG. 4, the radial projection 45 on the support ring 5 proceeds from the upper edge of the sleeve 11 and is thus located outside the chamber. When the chamber 13 is filled with initially formable material, the opening 31 then also forms a rotation-proof connection with the initially formable material. Obviously, it is also possible to combine the variant according to FIG. 4, for example, with the solution according to FIG. 1 or FIG. 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A spring strut unit comprising:
a cylinder;
a chamber formed around said cylinder, the chamber being at least partially filled with an initially formable material;
a spring plate having a sleeve section fitted around said cylinder and against said initially formable material so that said initially formable material, in a solidified state, transmits supporting forces along a path of force transmission from the cylinder to the spring plate; and
means for preventing rotation of the spring plate with respect to the cylinder in the path of force transmission.

2. A spring strut unit as in claim 1 further comprising a support ring permanently connected to said cylinder, said support ring forming said chamber.

3. A spring strut unit as in claim 2 wherein said support ring comprises a bottom fixed to said cylinder and a sleeve extending from said bottom around said cylinder, at least part of said sleeve section being received in said sleeve.

4. A spring strut unit as in claim 2 wherein said support ring comprises a connecting opening for receiving said initially formable material.

5. A spring strut unit as in claim 2 wherein said sleeve section comprises a circumferentially limited anti-rotation profile which receives said initially formable material.

6. A spring strut unit as in claim 2 wherein said support ring comprises a circumferentially limited engagement profile which receives said initially formable material.

7. A spring strut unit as in claim 6 wherein said engagement profile comprises at least one pocket.

8. A spring strut unit as in claim 7 wherein said support ring has an edge, said at least one pocket extending only to a point below said edge.

9. A spring strut unit as in claim 5 wherein said sleeve section has an inside wall, said anti-rotation profile being provided in said inside wall.

10. A spring strut unit as in as in claim 6 wherein said support ring comprises a bottom fixed to said cylinder and a sleeve extending from said bottom around said cylinder, at least part of said sleeve section being received in said sleeve, said engagement profile being provided in the bottom of the support ring.

11. A spring strut unit as in claim 5 wherein said anti-rotation profile comprises at least one opening in the sleeve section of the spring plate.

12. A spring strut unit as in claim 5 wherein said support ring comprises a circumferentially limited engagement profile which receives said initially formable material, said unit further comprising an anti-rotation sleeve which engages in the anti-rotation profile of the spring plate and in the engagement profile of the support ring.

13. A spring strut unit as in claim 12 wherein said sleeve section has an end surface, said support ring comprises a connecting opening for receiving said initially formable material, and said anti-rotation sleeve has a flow connection between the end surface of the sleeve section and the connecting opening in the support ring.

14. A spring strut unit as in claim 12 wherein said support ring comprises a circumferentially limited engagement profile which receives said initially formable material, said anti-rotation sleeve being supported in a permanent axial position inside the engagement profile of the support ring.

15. A spring strut unit as in claim 5 wherein said support ring comprises a circumferentially limited engagement profile which receives said initially formable material, said engagement profile being received in said anti-rotation profile.

16. A spring strut unit as in claim 15 wherein the support ring has at least one radial projection which engages in the anti-rotation profile of the spring plate.

17. A spring strut unit as in claim 16 wherein the radial projection is located outside the chamber.
